(19) United States
(12) Patent Application Publication
(10) Pub. No.: US 2006/0000630 A1
(43) Pub. Date: Jan. 5, 2006

(54) Penetration fire stop device

(75) Inventor: Jeffrey Hemingway, Farmington, CT (US)

Correspondence Address: John C. Hilton;McCormick, Paulding & Huber, LLP, 185 Asylum Street, City Place II, Hartford, CT, 06103, US

(73) Assignee: The Wiremold Company, West Hartford, CT (US)

(21) Appl. No.: 10/783,941

(22) Filed: Feb. 20, 2004

(51) Int. Cl. H02G 3/04

(52) U.S. Cl. 174/58

(57) ABSTRACT

Fire Stop devices, for walls having cables that run through a wall opening, are provided on exposed ends of a conduit placed in the wall opening. Each fire stop device has a hollow housing fitted to the exposed end of the conduit, and a front wall of the housing has moveable cable clamping jaws to minimize the size of the slot through which the cables are provided. Intumescent material is provided inside the hollow housing. The rear wall of the housing has a separable back plate that contacts the conduit at only limited abutment surface to minimize heat transfer from the conduit to the housing.

### BACKGROUND

Normally conduits or pipes are provided in a wall structure to carry wires from one area of a building to another. The fire code dictates certain requirements for preventing the passage of air through such a conduit, and the present invention seeks to minimize the flow or air through such a conduit by providing a fire stop at one or both sides of the wall.

The prior art suggests that heat expandable foam fingers can be provided in the conduit within the wall so that the wires can pass between the fingers during installation, and so that the intemescent fingers when subjected to heat can expand to substantially fill the space within the conduit. U.S. Pat. No. 5,594,202 shows such a device where the conduit is a square tube made up of a base plus a cover (presumably to allow assembly of the various components).

Another approach is to provide a retrofit assembly comprising a split tube held together by couplings, and containing material of the heat sensitive foam type provided so that the foam material expands in response to heat from the fire and substantially seals off the area inside the tube, to minimize air flow and function as a fire stop.

Still another approach is shown in U.S. Pat. No. 6,176,052 where saw tooth fingers of intemescent material are provided in a split coupling provided at one end of the wall opening in which the conduit or wires are provided.

### SUMMARY OF INVENTION

The present invention relates to a coupling which is intended to be used between a wall and a conduit or raceway/tray outside that wall. The device might be used in pairs, one on each side of the wall, or might instead be used on only one side as shown in the photos of the prototype fabricated by the inventor.

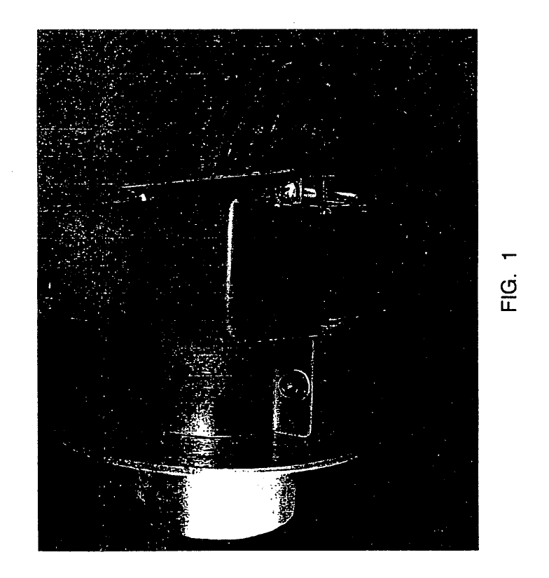

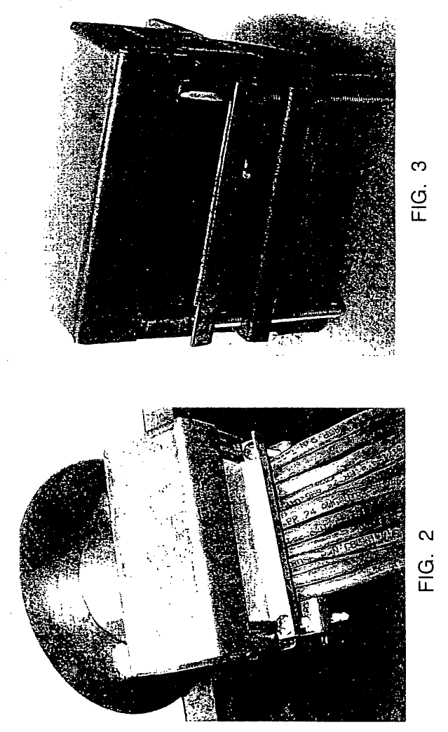

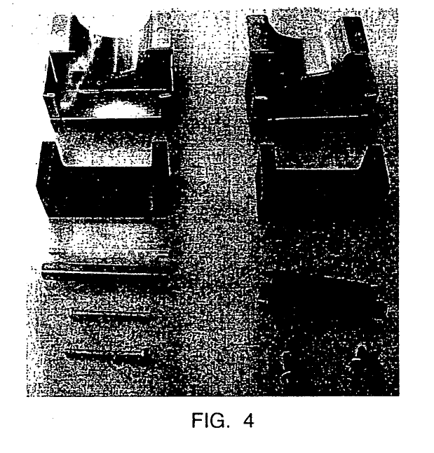

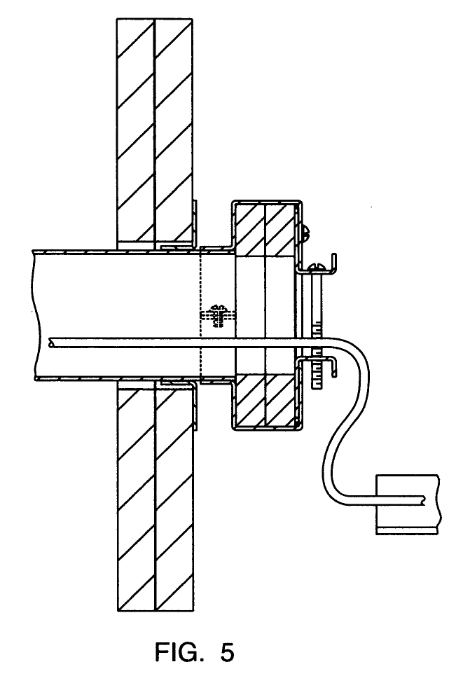

### BRIEF DESRCIPTION OF FIGS. 1-5

FIG./Photo No. 1 shows the preferred embodiment resting on a flat table that represents a wall (not shown) having an opening to receive an electrical conduit C. In the embodiment shown the wires run from a tray or raceway (not shown) into a device and then run through the conduit C through the wall.

FIG./Photo No. 2 illustrates the embodiment of FIG. 1/Photo No. 1 from a different vantage point and shows the rectangular housing.

FIG./Photo No. 3 shows the slot for receiving the wires that run through the housing.

FIG./Photo No. 4 shows the device disassembled to show the U-shaped intemescent blocks of heat expandable foam for placement in the housing where they can expand to cut off the airflow through the slot containing the wiring.

FIG. 5 is a vertical section taken through the wall, the conduit in the wall and the device plus the raceway of tray.

### DETAILED DESCRIPTION OF FIGS. 1-5

A flanged sleeve is first provided on the conduit which passes through the wall. The device further includes a housing having a clamping arrangement made up of two pieces to fit over the end portion of the conduit. This split collar arrangement supports a generally rectangular housing, also defined in two parts, and including flanges to bring the wires into alignment so that they are arranged alongside one another and emanate through a slit defined between the flanges as shown in the photos, and the FIG. 5 drawing.

Inside the rectangular housing a pair of U-shaped intemescent blocks are laid. These blocks are of the heat sensitive foam type that expand in response to heat. Thus they will fill the interior volume of the rectangular housing, and any space between the wire at the slit, thereby sealing the wires externally to the conduit in the wall. This sealing occurs at a location which is slightly spaced from the wall as the housing has the aforementioned split collar to allow it to attach to the conduit outside of the wall. Another such device can be mounted at the other side of the wall if desired. Alternatively, instead of providing heat expandable blocks in the box, a molded filler material can be provided, preferably of an intemescent material that exhibits fairly low heat conductivity to not only cut down on air flow through the box, but to also reduce heat transfer through the box, thereby increasing the fire rating of the fire stop device.

The conduit end or ends is thereby be rendered airtight. The extent to which the rectangular volume inside the housing is filled with intemescent or molded material will determine the degree of tightness (with respect to air) for the overall installation.

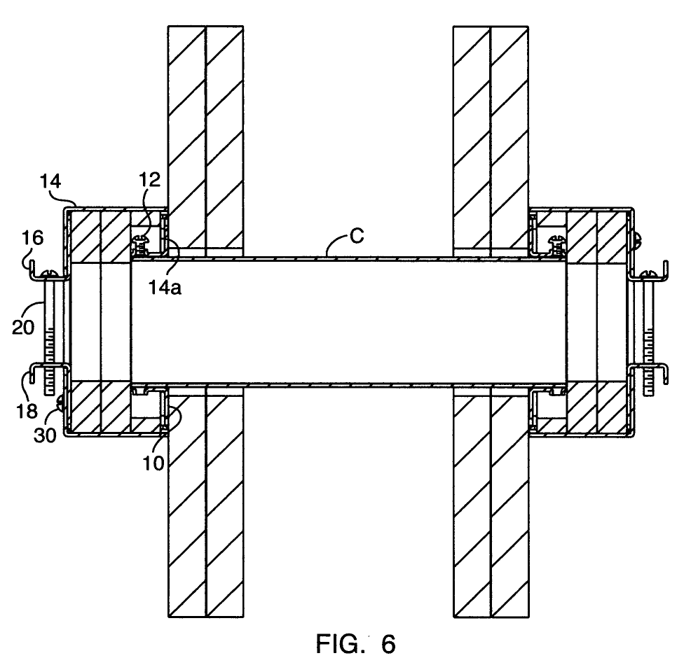

### BRIEF DESCRIPTION OF FIGS. 6-8

FIG. 6 is a vertical section taken through a wall having a conduit provided in the wall, and having fire stops in accordance with the present invention mounted on either side of the wall on the conduit.

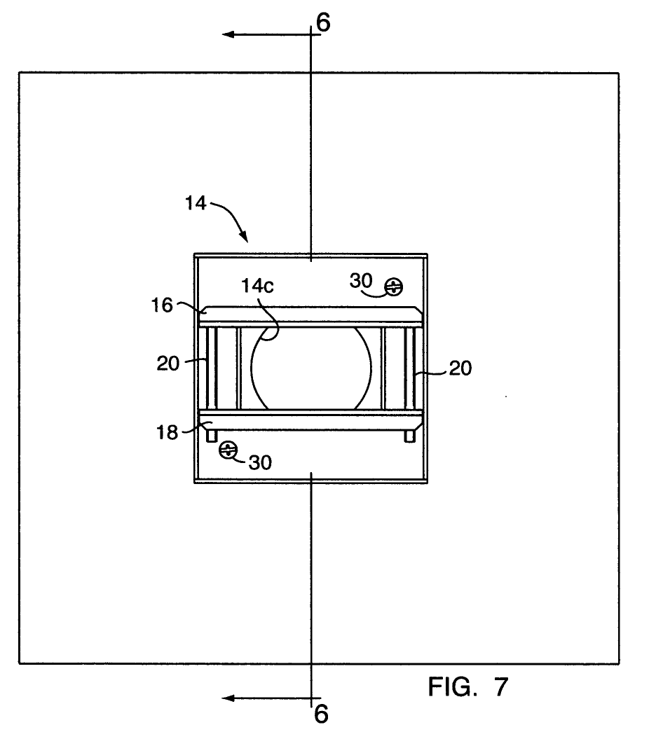

FIG. 7 is an end view of FIG. 6.

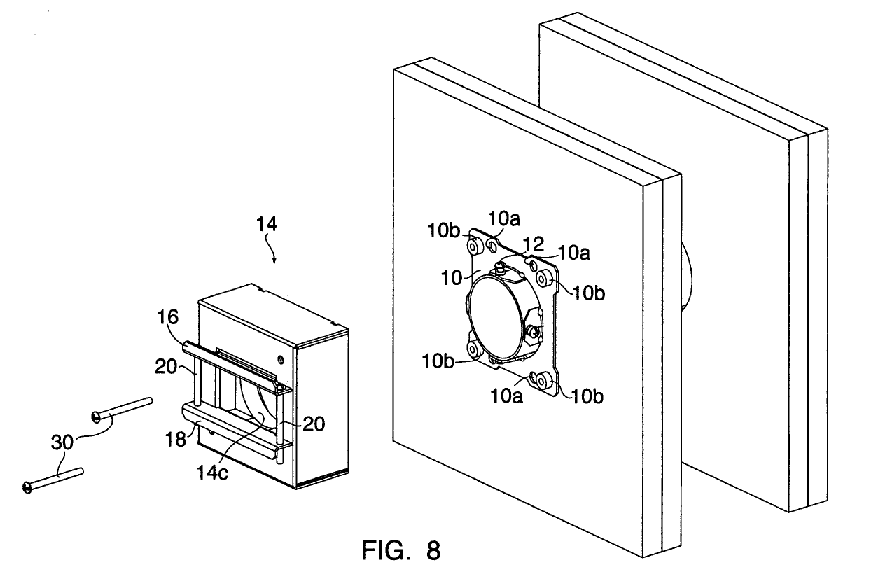

FIG. 8 is a perspective view showing in exploding relationship the various components of an assembly such as that depicted in FIGS. 6 and 7.

### DETAILED DESCRIPTION OF FIGS. 6-8

As shown in FIG. 6 a conduit C is provided in an interior wall of a building, the wall generally including gypsum board material on both faces as shown in FIG. 6. A plate forms a flanged collar 10 with tabs that are provided with set screws 12 that clamp plate 10 to the conduit C. The plate 10 is flush against, and is screwed in the gypsum wall board. A rectangular housing or wall box 14, is provided on the plate 10 such that it forms a rear wall 14a as shown to better advantage in FIG. 7. These components, being separately formed, provide for low heat transfer from the housing 14 to the conduit C.

The wall box 14 is generally similar in construction and configuration to that described above with reference to the first embodiment, and provision is made for locating intemescent heat expandable block material inside the rectangular housing or wall box as described above with reference to FIGS. 1-5.

Finally, the wires (not shown) extend outwardly through the opening defined between the adjustable doors 16 and 18 so as to allow screw fasteners 20 to clamp the wires in position again as described previously with reference to the first embodiment.

Still with reference to FIG. 6, a second fire stop may be provided on the opposite side of the wall for the same purpose, that is to isolate the air in one space defined by one side of the wall from air in the space defined by the opposite side of that same wall. This fire stop configuration is intended for installation when the wall is erected, rather than intended for use in a retrofit situation such as that described previously with reference to FIGS. 1-5 inclusively.

FIG. 8 illustrates in exploded relationship a preferred configuration for the collar provided on the wall surrounding the conduit. The rear wall of the rectangular housing can be seen to comprise a plate having a circular opening and flanges spaced circumaxially around that opening to receive set screws that anchor the faceplate to the conduit. The plate further includes threaded portions at the four corners of the rectangular or square plate which are adapted to receive screws 30 that allow the wall box 14 to be conveniently assembled to the plate 10. The plate 10 may include openings 10a which serve to facilitate anchoring that plate to the wallboard. The raised bosses provided at the four corners of the plate 10 and illustrated at 10b are intended to receive the threaded end of the fasteners 30, 30. Relying solely upon the connection between the faceplate 10 and the rear of the box 14, the box 14 need not have any annular collar 14c such as shown in FIGS. 1-5 and defined by a rearwall for that wall box 14. This FIG. 8 construction benefits from a reduction in the rate of heat transfer between the components of the device from that provided in FIGS. 1-5. The doors 16 and 18 are also shown in FIG. 8, and are similar to those illustrated in FIG. 6.

1. A device for use in a wall structure having an opening that is provided with a through conduit, said device comprising a housing, means for securing the housing to the conduit, said housing being of generally rectangular housing shape and having a rearwall defining an opening communicating with the interior of the conduit intumescent materials provided in said rectangular housing, and clamping means provided in a side of said housing opposite the conduit, said clamping means defining a slot for the wires passing through the conduit and through said housing, said wire clamping means serving to minimize the cross-sectional area occupied by the wires at said side of said housing opposite the through conduit.

2. The device according to claim 1 wherein said wire clamping means defines an elongated slot such that wires passing through the slot are arranged along side one another thereby, minimizing the cross-sectional area occupied by the wires contained in said slot.

3. The device according to claim 2 above wherein said housing is of metal material in order to minimize distortion due to heat.

4. The combination according to claim 3 above wherein said housing is formed integrally with said means securing said housing to said conduit.

5. The combination according to claim 3 wherein said means for securing said housing comprises a plate having a conduit opening to receive said conduit, said plate having bent tabs that are provided, with fasteners to clamp the plate to the conduit, and fasteners securing said housing to said plate.

6. The device according to any of the preceding claims wherein said wire clamping means is formed integrally with said housing and is fabricated from metal to minimize distortion due to heat.

7. The device according to claim 5 wherein said intumescent material is molded to fit snugly in said housing and having a recess for receiving said conduit.

8. The device according to claim 7 wherein said intumescent material is of low heat transfer/conductivity.
